(19) United States
(12) Patent Application Publication
(10) Pub. No.: US 2007/0288630 A1
(43) Pub. Date: Dec. 13, 2007

(54) Quality of Service Monitor in a Packet-Based Network

(76) Inventors: Giuseppe De Noia, Torino (IT); Antonio Fusco, Torino (IT); Andrea Roasio, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/660,383

(22) PCT Filed: Aug. 20, 2004
(86) PCT No.: PCT/EP04/51874

§ 371 Date: Feb. 16, 2007

(51) Int. Cl. G06F 15/173

(52) U.S. Cl. 709/224

(57) ABSTRACT

A method and system of monitoring quality of service in a packet-based network includes a three-tier architecture, wherein one or more applications can request customized quality of service reports from a quality server. The customized reports may include, for example, a desired report format or trigger events indicating when the one or more applications should receive the report. The quality server prepares these reports based on quality of service messages received from user terminals and sends the reports in accordance with the request.

### TECHNICAL FIELD OF THE INVENTION

The present invention relates generally to networks, and, more particularly, to monitoring quality of service (QoS) in a packet-based network.

### BACKGROUND ART

Intense competition is expected in the information-networking arena over the next decade. As the competition increases, it is essential for companies to position themselves appropriately taking advantage of their core competencies and preparing for the emerging telecommunications technology. In this competitive environment, mergers, alliances, and new entrants in the market place have service providers searching for innovative ways to retain and attract subscribers. Today's service providers are striving to differentiate themselves within this expanding competitive landscape by searching for ways to bundle new services for their customer base. Consequently, many service providers are looking to Next Generation Networks (NGN) as a means to attract new customers.

NGN is a term used to designate upcoming telecommunication networks based on IP technology that deliver integrated voice and data services. An NGN can be thought of as a packet-based network where the packet switching and transport elements, such as routers, switches, and gateways, are logically and physically separated from the service/call control intelligence. This control intelligence is used to support all types of services over packet-based transport network, including everything from basic voice telephony services to data, video, multimedia, and advanced broadband.

QoS is an important element in ensuring robust growth of NGN, and may include monitoring one or more of the following:
Service availability, such as the reliability of the user's connection to Internet Service.
Delay (also called latency), such as the time interval between transmitting and receiving packets.
Delay variation or jitter, which refers to the variation in time duration between all packets in a stream taking the same route.
Throughput, which is the average or peak rate at which packets are transmitted.
Packet loss rate resulting from congestion that is the maximum rate at which packets can be discarded during transfer through a network.

To be competitive, companies will have to ensure that the network is maintaining proper QoS levels and/or SLA (Service Level Agreement) standards for mobile users to experience rich multimedia services. Examples of QoS enforcement techniques on the network elements include integrated services and differentiated services. Integrated services (also called Int-Serv) uses the Resource Reservation Protocol (RSVP) and is implemented at the edge of enterprise networks where user flows can be managed at the desktop user level. This protocol assumes that resources are reserved for every flow requiring QoS at every router hub in the path between receiver and transmitter, using end-to-end signaling and must maintain a per-flow soft state at every router in the network. Differentiated service (also called Diff-Serv) minimizes signaling and concentrates on aggregated flows and per-hub behavior (PHB) applied to a network-wide set of traffic classes. Differentiated services ensure that downstream nodes receive the information required to handle packets arriving at the respective entry ports and forward such packets appropriately to the next routers.

Measurement of QoS is another important issue in NGN. Some proposed solutions include invasive and non-invasive techniques.

Invasive techniques inject artificial traffic using traffic generators that load the networks in order to verify round-trip delay, packet rate and connectivity. Unfortunately, these invasive techniques inject undesirable traffic on the network. Additionally, these techniques do not provide a punctual per-session QoS measurement because the traffic injection is not synchronous with the actual traffic. Finally, QoS measurement is of the injected traffic rather than the actual traffic, which further dilutes the value of the measurements.

Non-invasive measurements have also been proposed. For example, QoS monitoring can be achieved by using probes that measure QoS parameters of traffic streams. This technique allows for the identification of sessions and participants and the measurement of error rates, packet loss, jitter, and delay for each stream of conversation. Unfortunately, the use of probes has limited scalability because the probes are expensive to install and maintain.

FIG. 1 shows another example of a non-invasive approach described in an IETF paper called “Real-Time Application Quality of Service Monitoring (RAQMON) Framework” by Anwar Siddiqui, Dan Romascanu, and Eugene Golovinsky. A first IP device 12, such as a cellular phone, includes internal hardware necessary to run an application 13. The first device 12 communicates with a second IP device 14, also containing an application 16, using a setup protocol, such as SIP (session initiation protocol). After the setup, the two IP devices communicate through RTP (Real-time transport protocol), which is the Internet-standard protocol for the transport of real-time data, including audio and video and which can be used for media-on-demand and interactive services, such as Internet telephony. To monitor QoS, a RAQMON data source 18 is embedded in the IP device 14. This RAQMON data source (RDS) acquires QoS information produced by the application 16 during a multimedia session. QoS information is then transmitted to RAQMON report collectors 20 (1-N) through a RAQMON protocol data unit (PDU) carried by either RTCP (Real-Time Control Protocol) application or SNMP (Simple Network Management Protocol) as indicated at 22. The report collectors 20 act as a database that store QoS information, maintain historical data, and report the data to a network management application 26 for analysis.

There are several problems with the QoS solution of FIG. 1. First, the RDS 18 in the IP end device 14 must store a significant amount of historical data, which takes a lot of storage capacity and is expensive. Additionally, the IP end device 14 must be able to handle 3 protocols including: a signaling protocol for call setup (e.g., SIP), a protocol to send PDU (e.g., SNMP), and RTP. Each protocol requires separate software applications and separate memory areas needed to support the protocol. Additionally, the RRC 20 must be a somewhat sophisticated machine, which compromises the scalability in large networks due to cost.

FIG. 2 shows another solution described in US application number 2003/0120773 A1 to Mueller et al. A terminal 30 communicates through a router 32 and a gatekeeper 34. A second terminal 36 also communicates through a router 38 and a second gatekeeper 40. A central post-processing device 42 (CPP) and a performance monitoring unit 44 (PMON) are assigned to communicate with the gatekeepers 34, 40 for receiving QoS information. The gatekeepers 34, 40 must perform the functions of collecting, processing, storing and delivering processed data to the monitoring applications 42, 44. Not only are the gatekeepers fairly expensive components, but also the scalability of the solution is significantly hampered because the gatekeepers can only handle a limited number of terminals.

Therefore, what is needed is a method and system to monitor QoS in networks including mobile devices without reducing communication efficiency and increasing cost and complexity.

### OBJECT AND SUMMARY OF THE INVENTION

The present invention therefore provides a method and system for monitoring QoS in a packet-based network, such as the Internet, that overcomes the shortcomings of the prior art.

The Applicant has found that by using a three-tier architecture wherein one or more applications (herein below called “subscribers” or “watchers”) can request customized QoS reports from a quality server using a subscription request, and wherein, in response, the quality server prepares these reports based on QoS messages received from user terminals during their communications and sends the reports to the subscribers in the requested form, very flexible and low-cost QoS monitoring can be performed and high scalability of the network can be achieved.

The three-tier architecture of the present invention provides more scalability thanks to the presence of a mediation element, whereas with a two-tier architecture messages are directly exchanged by applications and terminals. Scalability is further achieved because the quality server is required to store only little history data (until the report is sent to the subscriber).

Moreover, the subscription functionality allows selectivity in that different subscribers can subscribe to different services or to a same service (possibly with different parameters) by a simple subscribe message. In particular, a subscriber can request from the quality server specific report formats and trigger points upon which the reports are sent.

Still further, the QoS information is sent over a packet-based network from the user terminals to the quality server (or “event” server) using the same protocol used to setup the user communications allowing for an efficient and low-cost QoS monitoring solution with high scalability.

According to a first aspect thereof, the present invention thus relates to a method of monitoring quality of service in a packet-based network, the network being suitable to establish communications between user terminals, the method comprising:

requesting a quality-of-service report for at least a communication between two of said users terminals, wherein requesting including providing information relating to a customization of the quality-of-service report;

receiving from the two user terminals quality-of-service information related to the communication; and

providing the report based on the quality-of-service information and on the customization information.

Advantageously, requesting a customized report comprises indicating the type of information to be included in the QoS report.

Preferably, the method further includes providing a plurality of notification services, each notification service including provision of at least a respective quality-of-service report.

Requesting a quality-of-service report preferably includes subscribing to one of said notification services.

The quality of service information is preferably received using a first protocol and the communication is established using a second protocol different from the first protocol.

Preferably, the communication is set-up using the first protocol, before establishing the communication.

The customization information may include specification of one or more trigger events related to the communication and the report may be provided in response to a trigger event.

The customization information may also comprise specification of a desired report format and the report may be provided in the specified report format.

These information concerning the report may be specified when subscribing to a notification service. In particular, subscribing to a notification service may comprise specifying a desired report format and one or more trigger events for the provision of the report.

Advantageously, the packet-based network is an Internet-based network. Moreover, the first protocol may be a session initiation protocol (SIP) and the second protocol may be an Internet real-time protocol (RTP).

Setting up the communication preferably includes:

receiving from a first of the user terminals an invitation to communicate with a second of the user terminals;

searching for the Internet protocol address of the second user terminal;

transmitting the invitation to communicate to the Internet protocol address of the second user terminal;

receiving from the second user terminal an acceptance of the invitation to communicate; and

transmitting the acceptance to the first user terminal.

The communications between user terminals is preferably established through a multimedia channel including voice and data.

The report may comprise call detail record data.

In this case, providing the report comprises matching the call detail record data with the quality-of-service information based on a call identifier.

The trigger events may include overcoming a predetermined limit by a parameter related to the communication.

Alternatively or in addition, the trigger events may include termination of the communication.

The quality-of-service information is preferably received during the communication.

The method may further comprise taking a correcting action in said packet-based network in response to the report provision.

In a second aspect thereof, the present invention relate to a system for monitoring quality of service in a packet-based network, the network being configured to establish communications between user terminals and the user terminals being configured to provide quality-of-service information related to the communications;

the system comprising:

a subscriber configured to send a request for a quality-of-service report for at least a communication between two of the user terminals, the request including information relating to a customization of the quality-of-service report; and
a quality server configured to receive from the two user terminals quality-of-service information related to the communication, and to provide the quality-of-service report based on the quality-of-service information and on the customization information.

The user terminals are preferably suitable to provide the quality-of-service information using a first protocol and to establish the communications using a second protocol different from the first protocol.

The first protocol may be a session initiation protocol (SIP).

Moreover, the user terminals are preferably suitable to setup the communications using the first protocol.

The packet-based network is preferably an Internet-based network.

The report advantageously includes the quality-of-service information received from the user terminals.

Moreover, the customization information may include one or more trigger events. In addition or in alternative, the customization information may include a desired report format.

The quality server preferably includes a report generator and a subscription register, the subscription register being suitable to register the trigger events and the report format.

The quality server is preferably suitable to receive the quality-of-service information contemporaneously while the user terminals are communicating with each other.

The communications preferably include voice and data.

Advantageously, the user terminals, the quality server and the at least a subscriber implement a three-tier architecture.

In a further aspect thereof, the present invention relates to a software program capable of implementing the method previously described.

### BRIEF DESCRIPTION OF THE DRAWINGS

For a better understanding of the present invention, a preferred embodiment, which is intended purely by way of example and is not to be construed as limiting, will now be described with reference to the attached drawings, wherein:

FIG. 1 is a block diagram of a prior-art system for monitoring QoS.

FIG. 2 is a diagram showing a prior-art system according to US patent application number 2003/0120773 A1.

FIG. 3 is a block diagram showing a system for monitoring QoS according to the invention.

FIG. 4 shows an exemplary implementation of the system of FIG. 3 using a SIP network.

FIG. 5 is a flowchart of a method for monitoring QoS using the system of FIG. 3.

FIG. 6 shows a block diagram of a quality server.

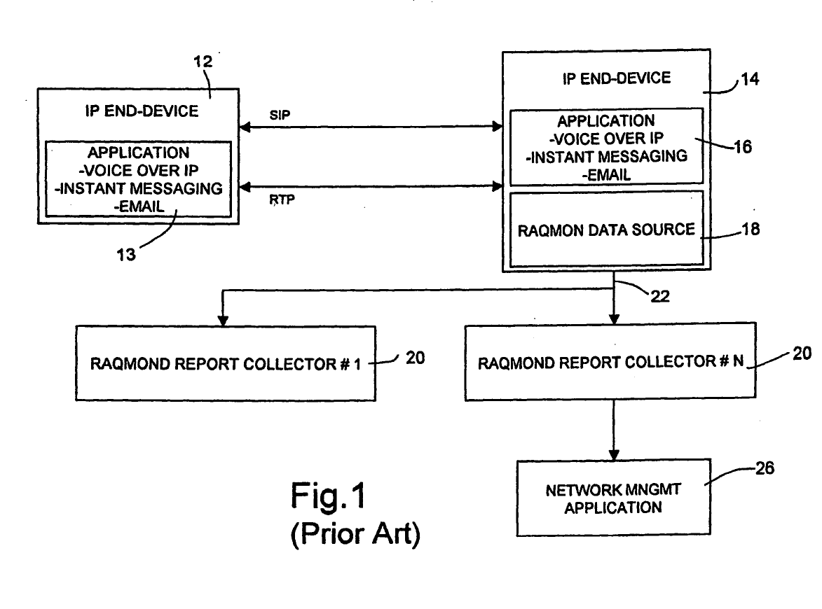

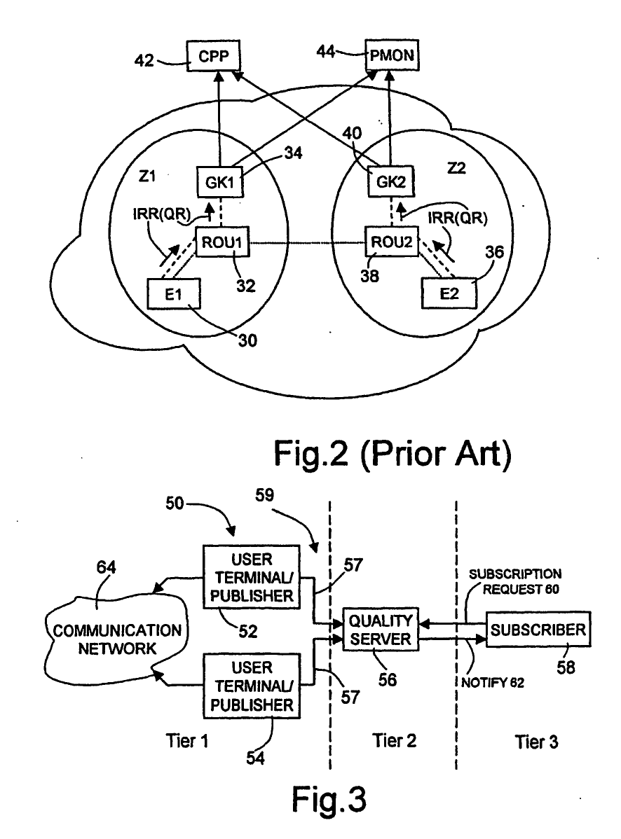

### DETAILED DESCRIPTION OF PREFERRED EMBODIMENTS OF THE INVENTION

Referring to FIG. 3, a system 50 is shown having two user terminals 52, 54 that also function as publishers by collecting and publishing QoS information. The user terminals can be any type of communication device, such as IP phones, pagers, Instant Messaging clients, mobile phones, hand-held computing devices, etc. The user terminals send QoS information to a quality server 56 (also called “event server”) in the form of publish messages 57 using any desired protocol (e.g., SIP, H.323, JMS, etc.) over any desired packet-based network (shown generically at 59). As further described below, the quality server 56 is configured to receive QoS information from the user terminals and to generate quality reports there from. The quality server 56 is also coupled via a network to a subscriber 58, which is suitable to request from the quality server 56 specific QoS services to be notified by a quality report. In particular, the subscriber 58 is suitable to send a subscription request 60 to the quality server including information relating to the customization of the quality report. Such customization may include information regarding a format type for receiving QoS reports and/or trigger events indicating when the reports are to be sent. Additionally, the customization can be accomplished by selecting one of a group of predetermined possibilities, or the customization can be independently generated from scratch. The subscription request 60 may take a variety of forms depending on the application and may relate to a single call, a single user, a domain (all calls from/to a domain), etc. Reference will be made in the following to two illustrative services: a first service called “corrupted QoS notification”, triggered each time the quality of the communication between the users falls below a desired level, and a second service called “CDR (Call Detail Record) generation”, wherein an enhanced CDR (typically used for billing purposes) including QoS data is provided at the end of a communication. Those skilled in the art will readily recognize that many other information services are possible, related to the quality of the service provided by the system.

Upon detecting a trigger event, the quality server 56 sends the report, including QoS information and in accordance with the format type identified in the subscription request 60, to the subscriber 58 in a notify message as is shown at 62. Contemporaneously while the publish messages 57 are transmitted to the quality server 56, the user terminals 52, 54 have a point-to-point communication via a communication network 64 using any desired protocol (e.g., RTP).

The solution uses three tiers: tier 1 includes the user terminals 52, 54; tier 2 includes the quality server 56; and tier 3 includes the subscriber 58. Generally, communication between the tiers is accomplished using Internet-based networks, but other types of communication techniques may be used. The three tiers make the solution readably scalable so that additional quality servers can be added. The quality server 56 will generally support many user terminals and subscribers simultaneously, but for simplicity of illustration only two user terminals 52, 54 and a single subscriber 58 are shown. Scalability is further achieved because the quality server 56 only needs to store history data until the report is sent to the subscriber, which is generally shortly after the termination of the communication between the user terminals 52, 54. Other advantages include that different subscribers can request different services by using a simple subscription message 60 and that the user terminals may send frequent publish messages rather than store extensive history data. The quality server 56 acts as a filter by decoupling the published messages 57 from subscriber 58 and by providing the subscriber with only that which it requests. Another advantage of the solution is that the same protocol may be used for setup and for message publication, as further described below.

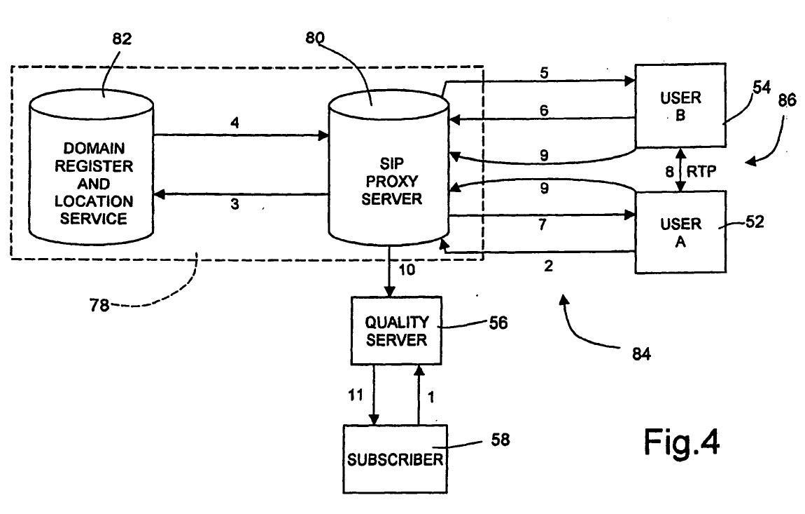

FIG. 4 shows a more detailed example where a packet-based network 78 (e.g., SIP network) is used as a basis for communication setup between the user terminals 52, 54 and for communication with the quality server 56. The SIP network includes a SIP proxy server 80 and a domain register and location service 82. The numbers 1-11 are shown to represent the normal sequence of events, although events may occur in a different order. As indicated at communication 1, the subscriber 58 sends a subscribe message to the quality server 56 via the proxy server 80. The subscription message includes customization information, such as indicating the service requested, the communications to be monitored (associated to one or more domains, users or calls), the trigger events and/or the report format desired.

Assume the “corrupted QoS notification” and “CDR generation” services are requested for the communication between users A and B. Assume also user A has a SIP phone and user B has a PC running a soft client that can support voice and video. Upon powering up, both users 52, 54 register their availability and their IP addresses with the SIP proxy server 80 in the ISP's network. Arrows 2 through 7 show the setting up of a communication using a first protocol, which is generically illustrated at 84. User A initiates the call (see arrow 2) by communicating to the SIP proxy server 80 that it wants to contact user B. The SIP proxy server then asks for the IP address of user B from the domain register server 82 (see arrow 3). The domain register server 82 replies with the IP address of user B (see arrow 4). The SIP proxy server 80 then relays the request of user A to communicate with user B (see arrow 5) including the medium or media that user A 52 wants to use (this communication can be accomplished using the Session Description Protocol (SDP)). User B 54 then informs the SIP proxy server 80 that user A's invitation is accepted and that User B is ready to receive a message (see arrow 6). The SIP proxy server communicates to User A 52 that the request is accepted (see arrow 7) thereby establishing an SIP session. The users 52, 54 then establish a point-to-point real-time protocol (RTP) connection enabling them to interact (see arrow 8). Such an establishment of a communication channel using a second protocol is generically indicated at 86. At any point during the communication, Users A and B publish asynchronous QoS messages (see arrows 9) to the SIP proxy server 80, using the same protocol as used to setup the communication 84. The SIP proxy server forwards these messages to the quality server 56. Although not shown, the SIP proxy server may also need to request from the domain register 82 the IP address of the quality server 56. The quality server 56 uses the QoS information to build a report, but also monitors the QoS data for predetermined trigger events. An example trigger event is if the quality of the communication between the users falls below a desired level. In such a case, the quality server 56 sends an asynchronous message (see arrow 11) to the subscriber 58 alerting the subscriber of the faulty communication (“corrupted QoS notification”). Moreover, corrective action may be taken as a feedback, such as to reinforce the connection or to limit admission on the same link for further communications. When the communication between the users 52, 54 is terminated, an asynchronous message (arrow 9) is sent to the SIP proxy server 80 indicating termination of the communication. This message is forwarded to the quality server 56 (see arrow 10), which in response builds a QoS report in the requested format (“CDR generation”). The report preferably contains QoS data and CDR data, matched by using the Call-id associated to the communication. The report is then forwarded to the subscriber via the proxy server 80 (see arrow 11). Those skilled in the art will readily recognize that the system of FIG. 4 need not be based on a SIP proxy server. For example, any signaling protocol can be used to setup the communication between Users A and B. Additionally, any asynchronous protocol may be used to communicate between the Users 52, 54 and the quality server 56. Furthermore, any asynchronous protocol may be used to communicate between the quality server 56 and the subscriber 58. Finally, any packet media transfer protocol can be used to communicate between users A and B. Although FIG. 4 generally shows a single domain, the system may easily be extended to a multiple domain environment, such as by using redirect servers between the domains.

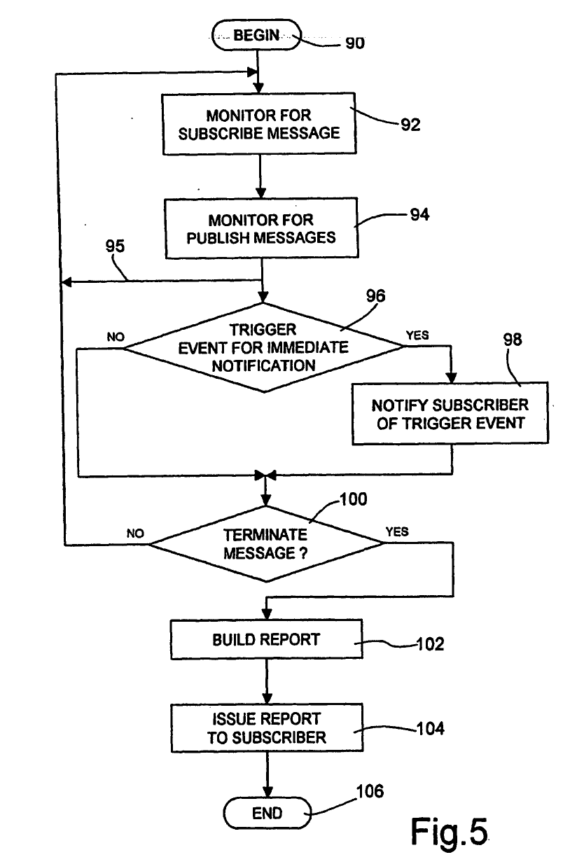

FIG. 5 shows a flowchart of a method to implement the quality server 56. In process block 90 the method begins. In process block 92, the quality server 56 monitors for a subscribe message from the subscriber 58. The subscribe message may define trigger events and the report format sent from the quality server to the subscriber. The communication between the quality server and the subscriber is generally an asynchronous communication and can take any desired format, but an example subscribe message in XML format could be as follows (two domains called “topolinia” and “paperopoli” are considered):

<?xml version=“1.0” encoding=“UTF-8”?>
<SUBSCRIBE

xmlns:xsi=“http://www.w3.org/2001/XMLSchema-instance”

xsi:noNamespaceSchemaLocation=“C:\Documents and

Settings\00917438\Desktop\ro8\qos through
sip\susbscribe2.xsd>

<Generation_CDR>

<Dominio>topolinia.wd<\Dominio>
<Dominio>paperopoli.wd<\Dominio>

</Generation_CDR>

</SUBSCRIBE>

The subscribe message may request a call detail record (CDR) that usually includes a start time, an end time and other information used for billing purposes. The subscribe message may also request immediate notification of any corruption on the communication between the users, so that the subscriber can take corrective action. In process block 94, the quality server 56 monitors for publish messages. The users send the publish messages contemporaneously while having a point-to-point communication between each other. Although the users may use other protocols for the publish message, it may be desirable to use the same protocol as used for the communication setup because the users will not be required to use extra program and stack space needed to support a separate protocol. For example, SIP is a protocol that can be used for both publish messages and for a call setup. The publish message is preferably an asynchronous message sent with configurable parameters and does not add considerable traffic to the network. A simple example of a publish message in XML, containing RTCP information, is as follows:

<?xml version=“1.0” encoding=“UTF-8”?>
<notify-publish
xmins:xsi=“http://www.w3.org/2001/XMLSchema-instance”
xsi:noNamespaceSSchemaLocation=“C:\notify_publish_5.xsd”
>

<call_id>kj1238921u219</call_id>
<date>2001-10-15T09:41:33</date>
<call_closed>true</call_closed>
<packet_RTCP>

<header>

<IP_address_A>163.162.76.1</IP_address_A>
<IP_address_B>163.162.24.1</IP_address_B>
<PT>200</PT>

</header>
<reportblock>

<cumulative_num_of_pckt_lost>1234</cumula

tive_num_of_pckt_lost>

<interarrival_jitter>45</interarrival_jitter>

</reportblock>

</packet_RTCP>

<notify-publish>

If no publish messages are received, the process repeats as shown at 95. However, if a publish message is received, then in decision block 96, the quality server 56 performs analysis on the publish message to see if there is an event that requires immediate notification to the subscriber 58. For example, if the quality of service during the communication between users falls below an acceptable level (for example, due to jitter over threshold or to an excessive number of packet lost), the quality server may send an asynchronous notify message to the subscriber as shown in process block 98. Such an asynchronous notify message may be a report format as requested in the subscribe message. Otherwise, in process block 100, the quality server analyzes the published message to determine if the communication between A and B terminated. If not, the process starts again at process block 92. If the communication has terminated, in process block 102 the quality server builds a report in conformance with that which was requested in the subscribe message. In process block 104, the report is asynchronously sent to the subscriber and the process ends at process block 106. Although not shown, the process starts again at process block 90 monitoring for messages.

An example report sent to the subscriber could be as follows:

<?xml version=“1.0” encoding=“UTF-8”?>
<notify-publish
xmlns:xsi=“http://www.w3.org/2001/XMLSchema-instance”
xsi:noNamespaceSchemaLocation=“C:\notify_publish_5.xsd”>

<Service_name>generation CDR<Service_name>

<call_id>kj1238921u219<call_id>
<date>2001-10-15T09:41:33</date>
<call_closed>false</call_closed>
<packet_RTCP>

<header>

<IP_address_A>163.162.76.16</IP_address_A>
<IP_address_B>163.162.24.145</IP_address_B>
<PT>200</PT>

</header>
<reportblock>

<cumulative_num_of_pckt_lost>524</cumulative_n

um_of_pckt_lost>

<interarrival_jitter>21</interarrival_jitter>

</reportblock>

</packet_RTCP>
</notify-publish>

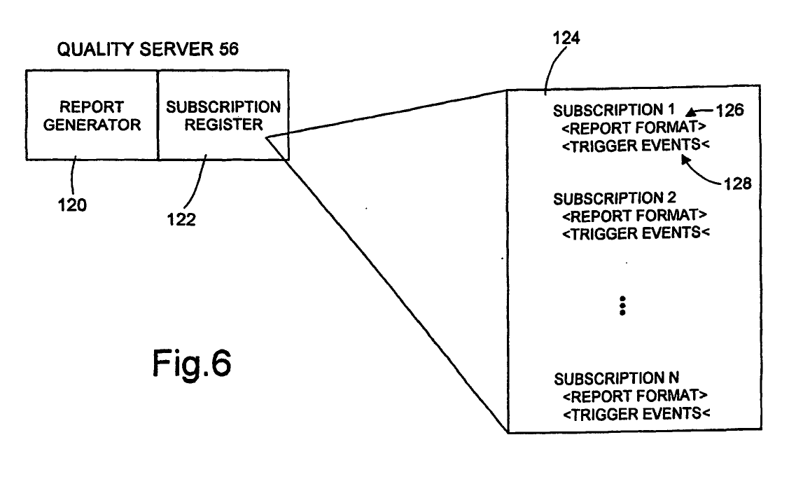

FIG. 6 shows the quality server 56 in more detail. The quality server generally includes two parts: a report generator 120 and a subscription register 122. The subscription register 122 stores a list 124 of subscriptions pertaining to one or more subscribers. Each subscription includes subscription information such as a report format 126 and trigger events 128. The report generator 120 analyzes the incoming publish messages from the user terminals and uses the publish messages to generate a report in conformance with the subscription register. The report generator also monitors the publish messages for trigger events. To complete the report, the report generator associates the user with one of the subscriptions in the list 124. Then the report generator uses the subscription information from the subscription register to generate the report in a format desired by the subscriber. The report is generally sent at the termination of the communication between users. However, the subscriber can control when the report is sent by setting trigger events in the subscription register.

The word “setup” or “setting up” a communication is generically used to refer to call setup or resource reservation.

It is clear that numerous modifications and variants can be made to the present invention, all falling within the scope of the invention, as defined in the appended claims.

In particular, although the invention has been described with particular reference to a SIP event framework, those skilled in the art will readily recognize that any other effective software technology can be used that allows to implement in an effective and performing way a three-tier event framework able to:

publish QoS data from the network terminals towards a mediation element (such as the quality server);

subscribe to services residing in the mediation element. This subscription can be made from the QoS applications (subscribers) towards the mediation element, and regards one or more specific services that the mediation element implements.

being notified of specific service dependent events generated by the service logic in the mediation element. The notification can be made in a selective way from the mediation element towards the QoS applications that subscribed the service.

Example of these software technologies are JMS (using Java APIs) and Web Services (using XML).

1-32. (canceled)

33. A method of monitoring quality of service in a packet-based network, said network being suitable to establish communications between user terminals, comprising in combination:
requesting a quality-of-service report for at least a communication between two of said user terminals, wherein requesting comprises providing information relating to customization of the quality-of-service report;
receiving from the two user terminals quality-of-service information related to said communication; and
providing said report based on said quality-of-service information and on said information relating to customization.

34. The method of claim 33, further comprising providing a plurality of notification services, each of said notification services comprising provision of at least a respective quality-of-service report.

35. The method of claim 34, wherein requesting a quality-of-service report comprises subscribing to one of said notification services.

36. The method of claim 33, wherein the quality of service information is received using a first protocol and said communication is established using a second protocol different from said first protocol.

37. The method of claim 36, further comprising, before establishing said communication, setting-up said communication using said first protocol.

38. The method of claim 33, wherein the information relating to customization comprises specifying one or more trigger events related to said communication and wherein said report is provided in response to a trigger event.

39. The method of claim 33, wherein the information relating to customization comprises specifying a desired report format and wherein said report is provided in said report format.

40. The method of claim 35, wherein subscribing to a notification service comprises specifying a desired report format and one or more trigger events for the provision of said report.

41. The method of claim 33, wherein the packet-based network is an internet-based network.

42. The method of claim 36, wherein the first protocol is a session initiation protocol.

43. The method of claim 36, wherein the second protocol is an internet real-time protocol.

44. The method of claim 37, wherein setting up the communication comprises:
receiving from a first of the user terminals an invitation to communicate with a second of the user terminals;
searching for the internet protocol address of the second user terminal;
transmitting the invitation to communicate to the internet protocol address of the second user terminal;
receiving from the second user terminal an acceptance of the invitation to communicate; and
transmitting the acceptance to the first user terminal.

45. The method of claim 33, wherein said communication is established through a multimedia channel comprising voice and data.

46. The method of claim 33, wherein said report comprises call detail record data.

47. The method of claim 46, wherein providing said report comprises matching said call detail record data with said quality-of-service information based on a call identifier.

48. The method of claim 38, wherein said trigger events comprise overcoming a predetermined limit by a parameter related to said communication.

49. The method of claim 38, wherein said trigger events comprise termination of the communication.

50. The method of claim 33, wherein said quality-of-service information is received during said communication.

51. The method of claim 33, further comprising taking a correcting action in said packet-based network in response to the report provision.

52. A system for monitoring quality of service in a packet-based network, said network being configured to establish communications between user terminals and said user terminals being configured to provide quality-of-service information related to said communications, comprising:
a subscriber configured to send a request for a quality-of-service report for at least a communication between two of said user terminals, the request comprising information relating to customization of the quality-of-service report; and
a quality server configured to receive from the two user terminals quality-of-service information related to said communication, and to provide said quality-of-service report based on said quality-of-service information and on said information relating to customization.

53. The system of claim 52, wherein the user terminals are suitable to provide said quality-of-service information using a first protocol and to establish said communications using a second protocol different from said first protocol.

54. The system of claim 53, wherein said user terminals are suitable to setup said communications using said first protocol.

55. The system of claim 52, wherein the packet-based network is an internet-based network.

56. The system of claim 52, wherein the report comprises the quality-of-service information received from the user terminals.

57. The system of claim 52, wherein the information relating to customization comprises one or more trigger events.

58. The system of claim 57, wherein the information relating to customization comprises a desired report format.

59. The system of claim 58, wherein the quality server comprises a report generator and a subscription register, the subscription register being suitable to register said trigger events and said report format.

60. The system of claim 53, wherein the first protocol is a session initiation protocol.

61. The system of claim 52, wherein the quality server is suitable to receive said quality-of-service information contemporaneously while said user terminals are communicating with each other.

62. The system of claim 52, wherein the communications comprise voice and data.

63. The system of claim 52, wherein said user terminals, said quality server and said at least a subscriber implement a three-tier architecture.

64. A software program capable of implementing the method according to claim 33.
